(19) United States
(12) Patent Application Publication
(10) Pub. No.: US 2023/0226979 A1
(43) Pub. Date: Jul. 20, 2023

(54) COMBINATION MIRROR AND DISPLAY SCREEN

(71) Applicant: DarkStar Vision Inc., Austin, TX (US)

(72) Inventor: Joseph Frank Scalisi, Austin, TX (US)

(21) Appl. No.: 18/155,668

(22) Filed: Jan. 17, 2023

Related U.S. Application Data
(60) Provisional application No. 63/300,545, filed on Jan. 18, 2022.

(51) Int. Cl. B60R 1/27; B60R 1/08; B60R 1/30

(52) U.S. Cl. CPC B60R 1/27; B60R 1/08; B60R 1/30; B60R 2001/1253; B60R 2300/30; B60R 2300/102; B60R 2300/106

(57) ABSTRACT

A system is provided that includes a housing [102], a display [100] attached to the housing [102], and a camera [104] attached to the housing located proximate the display [100], the camera [104] being configured to capture images over a 360-degree field of view in at least a first plane [110] through the housing and capture images over a 220-degree field of view in a second plane [112] perpendicular to the first plane [110].

The present application claims priority to U.S. Provisional Pat. Application No. 63/300,545, filed on Jan. 18, 2022, entitled “Combination Mirror and Display Screen,” the entire disclosure of which is incorporated by reference herein.

### INTRODUCTION

Rearview mirrors have traditionally been the preferred device for capturing visual activity occurring behind the back of the vehicle for observation by the vehicle driver. A need exists to expand the capability of the traditional function of a rearview mirror through easy substitution of a rearview display system that may function over or in place of a conventional rearview mirror.

### SUMMARY

A system is provided that includes a housing, a display attached to the housing, and a camera attached to the housing located proximate to the display. In some embodiments, the camera is configured to capture images over a 360-degree field of view in at least a first plane through the housing and capture images over a 220-degree field of view in a second plane perpendicular to the first plane.

In some embodiments, the camera is attached to an edge of the housing. In some embodiments, the system includes a processor coupled to the camera. In some embodiments, the system includes a night-vision system coupled to the camera.

The processor may be programmed by a computer-readable, non-transitory, programmable product, comprising code, executable by the processor, for causing the processor to do the following: recognize objects captured by the camera according to a predetermined characteristic and provide an alert in connection with recognition of an object.

The objects may include one or more weapons and one or more hazards. The objects recognized by the processor may include one or more human faces.

In some embodiments, the system includes supplementary code, executable by the processor, for causing the processor to cause the camera to zoom in on objects in the field of view of the camera recognized as a hazard by the processor.

The disclosure also includes a detachable rear-view driving system, comprising: a housing; an attachment system for detachably affixing over a rear-view mirror in a vehicle; a display attached to the housing; a camera attached to the housing located proximate the display, the camera being configured to capture images over a 360-degree field of view in at least a first plane through the housing and capture images over a 220-degree field of view in a second plane perpendicular to the first plane; a processor coupled to the camera; and a communication system coupled to the processor.

In some embodiments, the camera is attached to an edge of the housing, and the system includes a night-vision system coupled to the camera. The system may also include one or more additional cameras coupled to the display and the processor.

The foregoing and other features and advantages of the invention will be apparent from the following, more particular description of the preferred embodiments of the invention, the accompanying drawings, and the claims.

### BRIEF DESCRIPTION OF THE DRAWINGS

For a complete understanding of the present invention, the objects, and advantages thereof, reference is now made to the ensuing descriptions taken in connection with the accompanying drawings briefly described as follows.

FIG. 1 is a front view of a display having a camera attached thereto.

FIG. 2A. is a diagram illustrating a viewing system described herein.

FIG. 2B is a flowchart outlining the routine function of a viewing system as a result of programming.

FIGS. 3A and 3B illustrate front and back views of a combination mirror and display screen, including a housing.

FIG. 4 illustrates the viewing side of the combination mirror and display screen in greater detail.

FIGS. 5A and 5B illustrate front views of a handle for positioning a combination and display screen.

FIG. 6 is a side view of the combination mirror and display screen illustrating the first and second fields of view.

FIG. 7 illustrates a side view of the combination mirror and display screen coupled to a rearview mirror.

FIG. 8 illustrates a side view of the combination mirror and display screen coupled to a mounting bracket.

FIG. 9 is a front view/diagram illustrating the combination mirror and display screen coupled to a power source via a cable.

FIGS. 10A and 10B illustrate diagrams of the combination mirror and display screen coupled to a power source.

FIG. 11 illustrates a block diagram showing an embodiment that includes a rearview camera.

Reference numbers/symbols have been carried forward.

### DETAILED DESCRIPTION

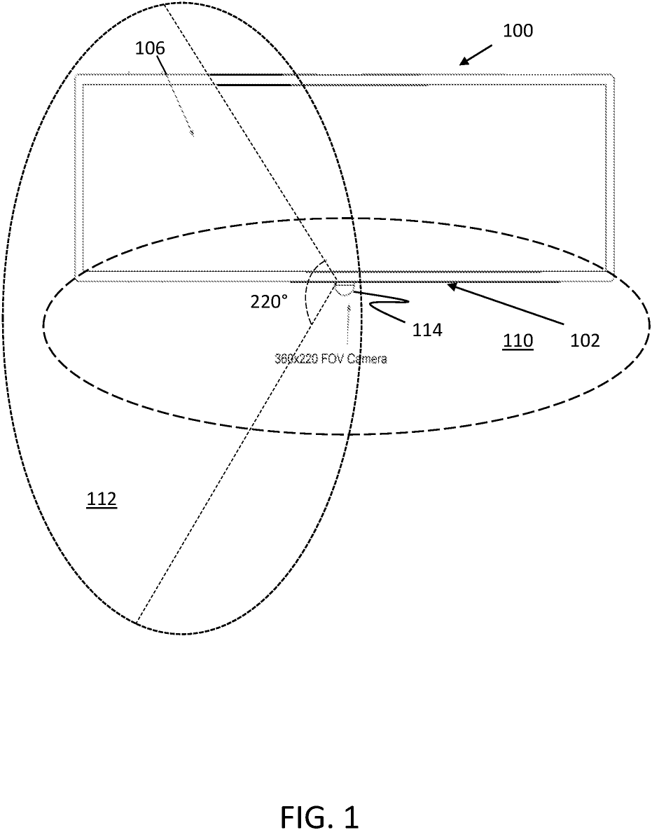

Preferred embodiments of the present invention and their advantages may be understood by referring to FIGS. 1-11, wherein like reference numerals refer to like elements.

Although certain embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations, in turn, in a manner that may be helpful in understanding certain embodiments; however, the order of description should not be construed to imply that these operations are order-dependent. Additionally, the structures, systems, and/or devices described herein may be embodied as integrated or separate components.

To compare various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

FIG. 1 is a front view of display 100, having camera 104 attached thereto. In some embodiments, camera 104 may be attached to housing 102 of display 100. Images from camera 104 may be viewed on screen 106 of display 100. Camera 104 may be a 360°camera that can capture images over a 360-degree field of view in at least a first plane 110 (partially illustrated within dotted lines) through the housing and capture images over a 220-degree field of view in a second plane 112 (partially illustrated within dotted lines) perpendicular to the first plane 110. Display 100 may include an audio interface 118. Audio interface 118 may have a microphone, a speaker, or both a microphone and speaker integrated within display 100. In some embodiments, audio interface 118 may be coupled to display 100 while lying apart therefrom. In some embodiments, display 100 may be positioned within a vehicle to serve a function that includes a rearview mirror.

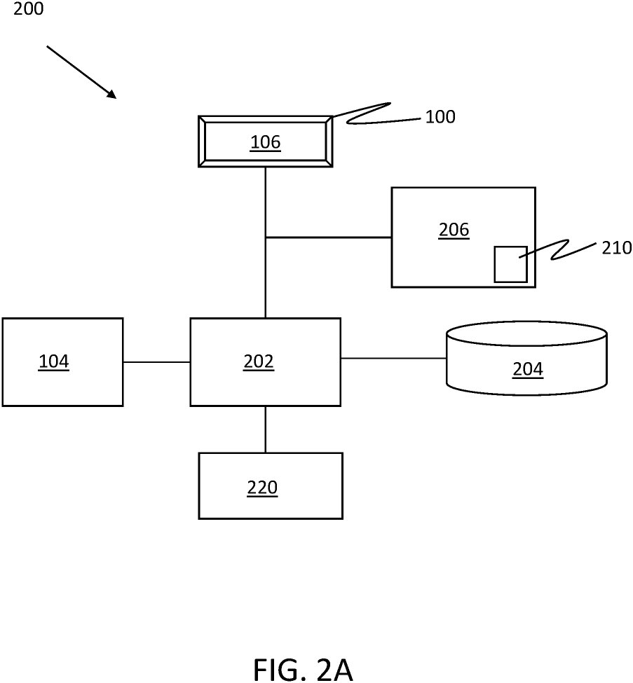

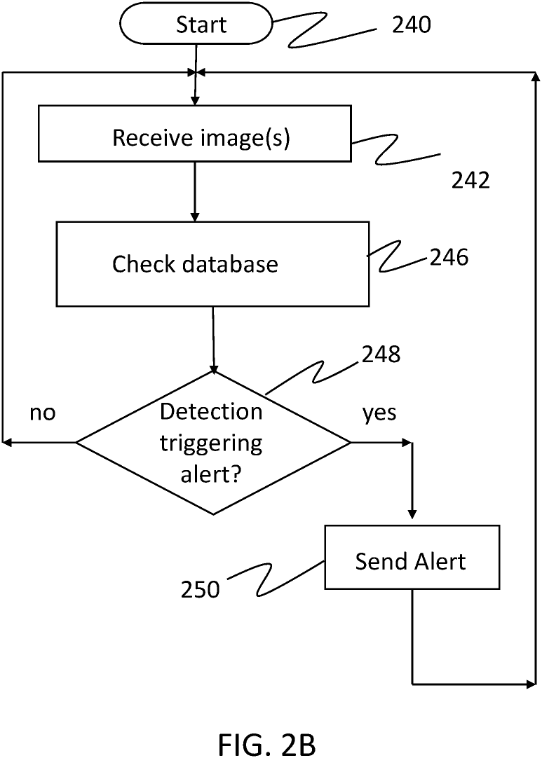

FIG. 2A. is a diagram illustrating a viewing system 200 described herein. Processor 202 is coupled to camera 104 and display 100 and memory/database 204. Memory/database 204 may be located locally with display 100. In some embodiments, local memory of memory/database 204 may include 4 gigabites (Gb) of onboard memory.

In other embodiments, memory/database 204 may be located remotely. Memory/database 204 may store images and information that may be accessed by processor 202 and/or sent from viewing system 200 in connection with processor 202 and images appearing on display 100. In some embodiments, processor 202 may be an onboard artificial intelligence (AI)/ neural net processor.

Auxiliary/additional camera system 206 may also be coupled to processor 202. Auxiliary/additional camera system 206 may include one or more cameras positioned within or outside a vehicle. Display 100 may receive information from processor 202 and camera 104 that enables display 100 to show images/video on screen 106. In some embodiments, camera 104 may be an infrared camera. In other embodiments, camera 104 and auxiliary/additional camera system 206 may include night vision capability, such as an infrared imaging system. In some embodiments, the night vision system may be an uncooled infrared (IR) imaging system 210.Additionally or alternatively, in some embodiments the night vision system is a passive color night vision system. A passive night vision system generally operates by way of ambient light and often operates at longer infrared wavelengths than an active system.

In some embodiments, screen 106 may be a plasma screen that interacts with camera 104 and/or auxiliary/additional camera system 206. In some embodiments, screen 106 may display different viewing modes, which may be selected in connection with touching various positions on the plasma screen embodiment of screen 106. Some of these view modes may include the display of multiple images from different cameras or the simultaneous display of multiple images from different cameras. In some embodiments, auxiliary/additional camera system 206 may include a 80 × 1, 80° camera mounted at the base of the display 100, for instance, within or near camera 104. In some embodiments, auxiliary/additional camera system 206 may include an optional second camera, which is wired or wireless, that serves as a dual camera, fed into display 100 along with camera 104.

In some embodiments, camera 104 and or auxiliary/additional camera system 206 may operate with light assist. Light assit is a light built provided with a camera or camera system, mounted near a lens that may assist in foucusing a camera during low light applications. In some embodiments, range of the camera may not be significantly affected whether light assist is used or not and as such light assist may be optional, although it may be applied to multiple cameras in auxiliary/additional camera system 206.

Objects on the screen that may prompt an alert include one or more weapons, one or more hazards, and one or more human faces. In some embodiments, processor 202 may be programmed with supplementary software to allow enhanced functionality for viewing system 200. One example of enhanced functionality may occur in connection with processor 202, causing camera 104 to zoom in on objects in the field of view of camera 104 recognized, by the processor 202, as a hazard, person of interest, weapon, etc.

Processor 202 may be programmed with image recognition software to detect certain human faces, conditions, events, and/or circumstances in connection with images appearing on screen 106. Alerts may be dispatched in connection with detection by showing an icon, color, blinking light, or other indication appearing on screen 106. Alternatively, or additionally, a sound may be emitted from a speaker of audio interface 118 in connection with an alert. Further, processor 202 may be connected to communications system 220, having a transmitter and/or receiver. In some embodiments, communications system 220 may be a transceiver. Images detected by processor 202 due to its image processing programming may result in an alert being dispatched to a remote location through communication system 220. Face recognition data may be accessed locally from memory/database 204 and/or from memory/database located remotely through communication system 220. In some embodiments, one or more images (including video) prompting an alert may be stored locally in memory/database 204. Alternatively, communication system 220 may access a memory/database 204 located remotely from display 100. In some embodiments, a facial identification (ID) system may be implemented with memory/database 204 in conjunction with programming of processor 202 and communication system 220 to produce a security verification alarm system. With such a system, an alert may be produced near viewing system 200 or at a remote location in conjunction with display information from viewing system 200. In some embodiments, an object recognition system may be implemented with memory/database 204 in conjunction with programming of processor 202 and communication system 220. Consequently, with such an object recognition system, hazardous objects may recognized in display 100 producing an alert. The object recognition system may be further expanded to implement a collision avoidance and or vehicle navigation system such as a vehicle parking system.

FIG. 2B is a flowchart outlining the routine function of viewing system 200 as a result of programming. After start (step 240), which may occur in connection with a vehicle start, image(s) are received (step 242) as a result of a camera feed to the display (106 of FIG. 2A). At step 246, a database (e.g., memory/database 204 of FIG. 2A) is accessed and checked to determine whether an image has been detected or whether images have been detected, according to the programming, that should trigger an alert. Such images may include specific people recognized through face recognition programming, perceived hazards, safety concerns, etc. At step 248, according to the system programming, processor 202 (FIG. 2A) determines whether an alert should be sent based on an image or images appearing on display 100 (FIG. 2A), such alert occurring in connection with detecting a hazard, certain faces (e.g., criminals and other offenders), weapons, etc. At step 250, an alert may be sent to a remote location via the communication system 220 (FIG. 2A). Additionally, or alternatively, an alert may produce an indication locally at the viewing system near or on display 100 (FIG. 2A) such as a sound (buzzer, beep), light (blinking light or light of a particular color (red light or red blinking light), etc. Although not explicitly shown, viewing system 200 (FIG. 2A) may include a speaker and/or lights of various types on display 100 (FIG. 2A) for producing audio or visual alerts.

Additional embodiments following that may be combined with or stand apart from the foregoing. In some embodiments, the term “rearview mirror” references a display screen that functions as a rearview mirror in, for instance, a vehicle. Especially, by virtue of its intended positioning, largely within a vehicle, the systems disclosed herein may operate in adverse weather conditions.

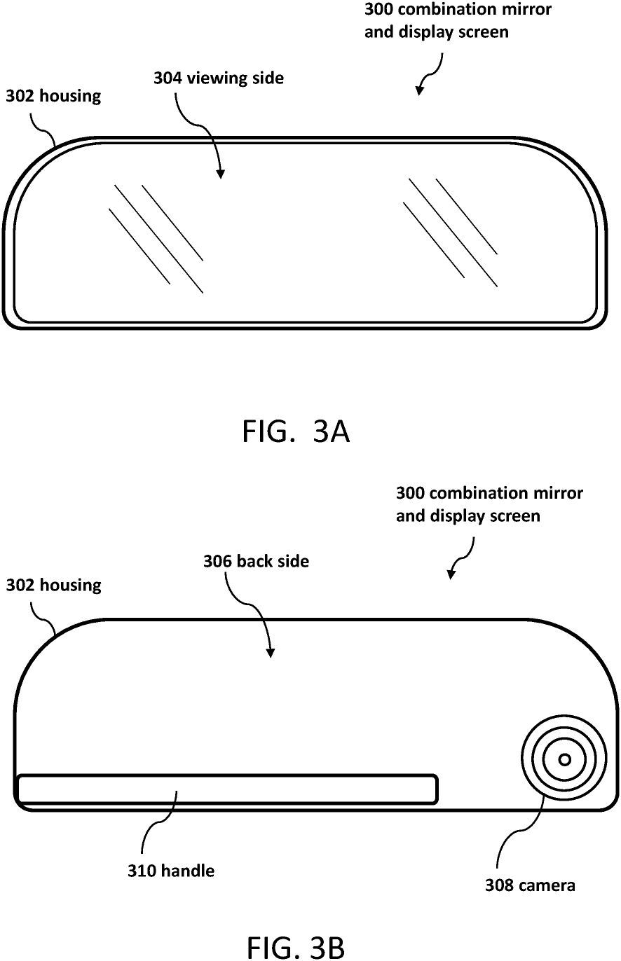

FIGS. 3A and 3B illustrate front and back views, respectively, of combination mirror and display screen 300, including housing 302. As indicated in FIG. 3A, combination mirror and display screen 300 may include viewing side 304. In some embodiments, a combination mirror and display screen 300 includes backside 306. As demonstrated in FIG. 3B, combination mirror and display screen 300 may include camera 308 and handle 310 coupled to backside 306. In some embodiments, camera 308 is configured to capture passive color night vision. Camera 308 may also be configured to capture normal vision during bright light, such as during the day. In some embodiments, camera 308 is configured to automatically adjust the video and/or image capture method based on ambient light detection.

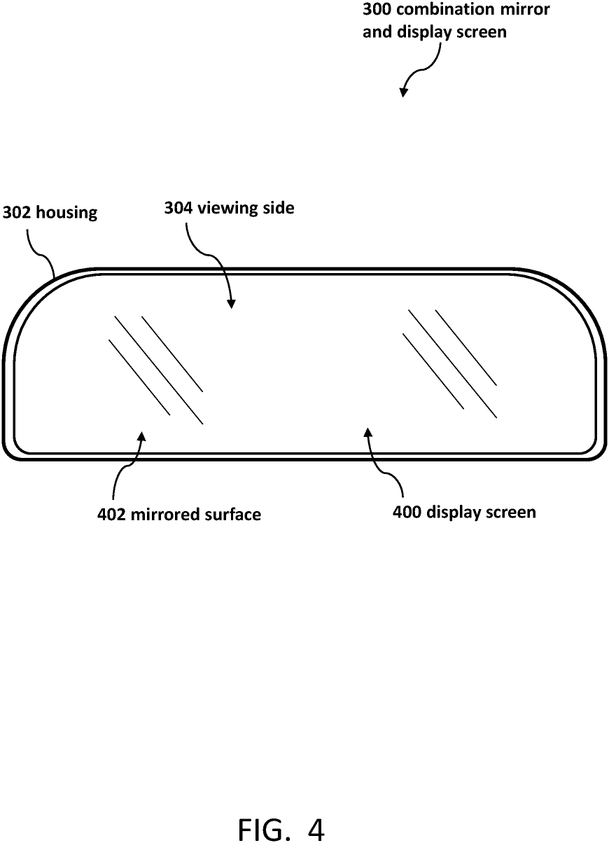

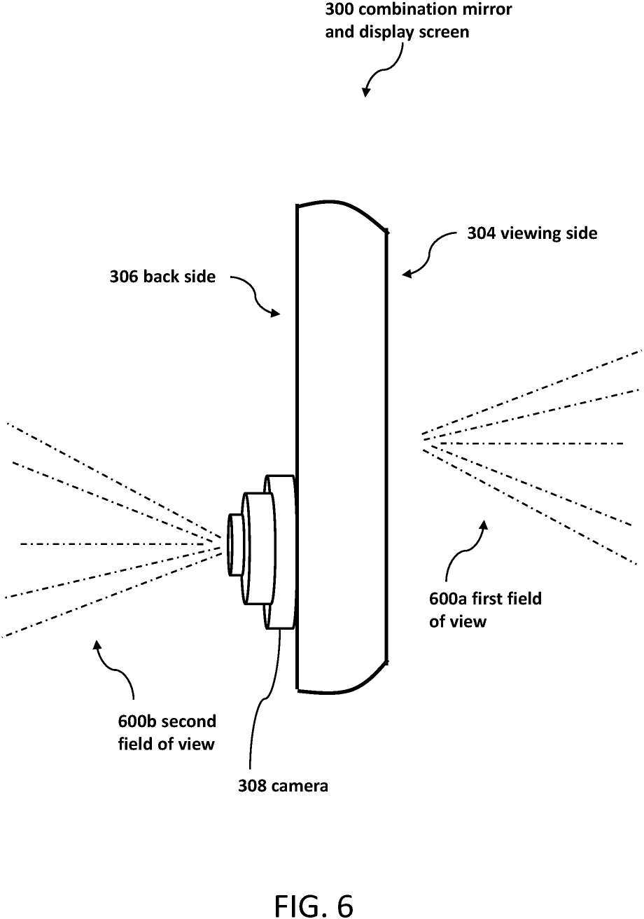

FIG. 4 illustrates the viewing side 304 of the combination mirror and display screen 300 in greater detail. In some embodiments, viewing side 304 includes display screen 400. Display screen 400 may comprise mirrored surface 402, as shown in FIG. 4. In some embodiments, mirrored surface 402 is configured to reflect a first field of view 400a (as shown in FIG. 6). In addition, display screen 400 may be communicatively coupled to camera 308 such that the display screen 400 is configured to display a view recorded by the camera 308. Camera 308 and display screen 400 will be discussed further with reference to FIG. 6.

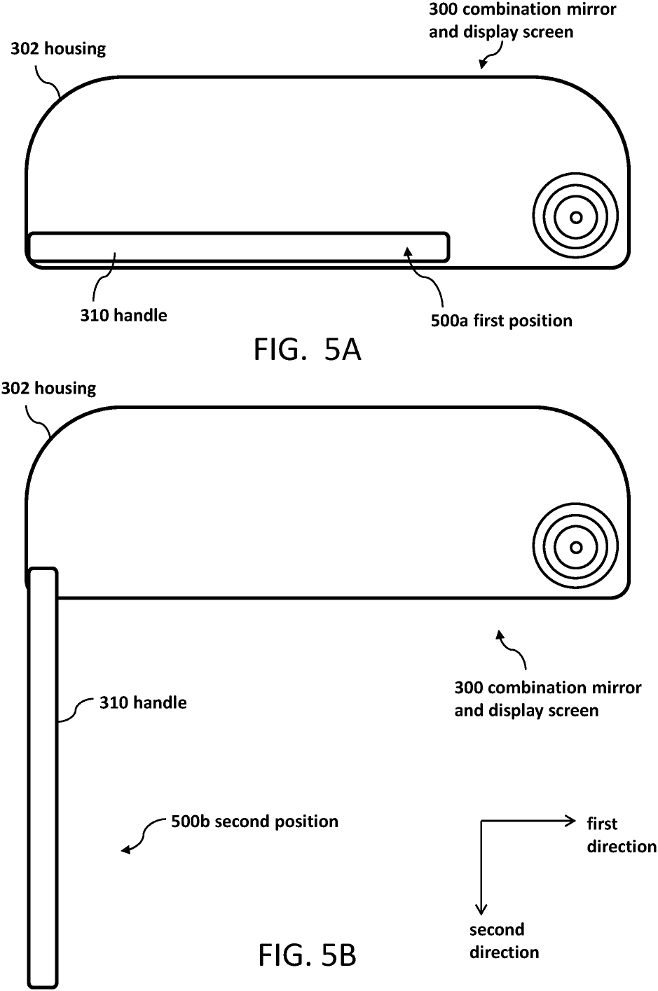

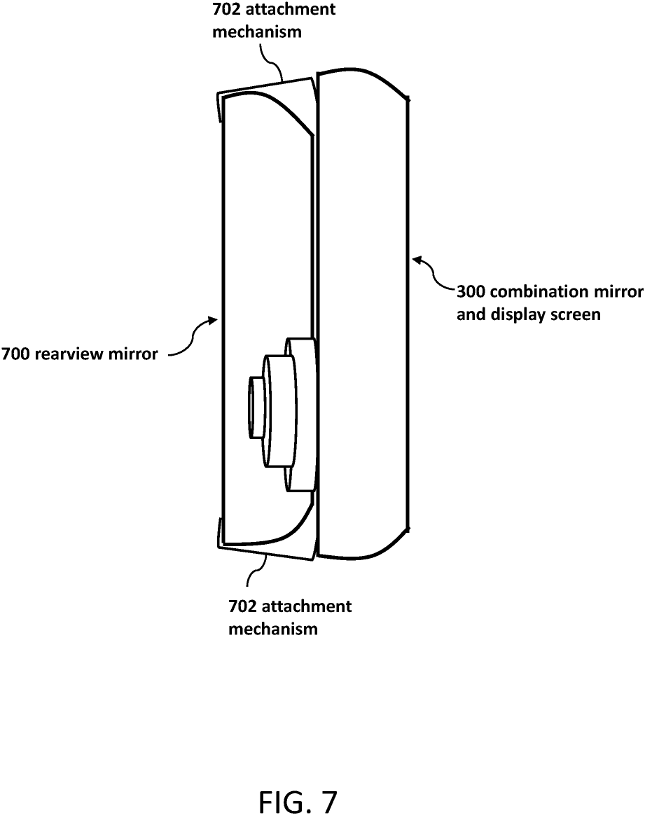

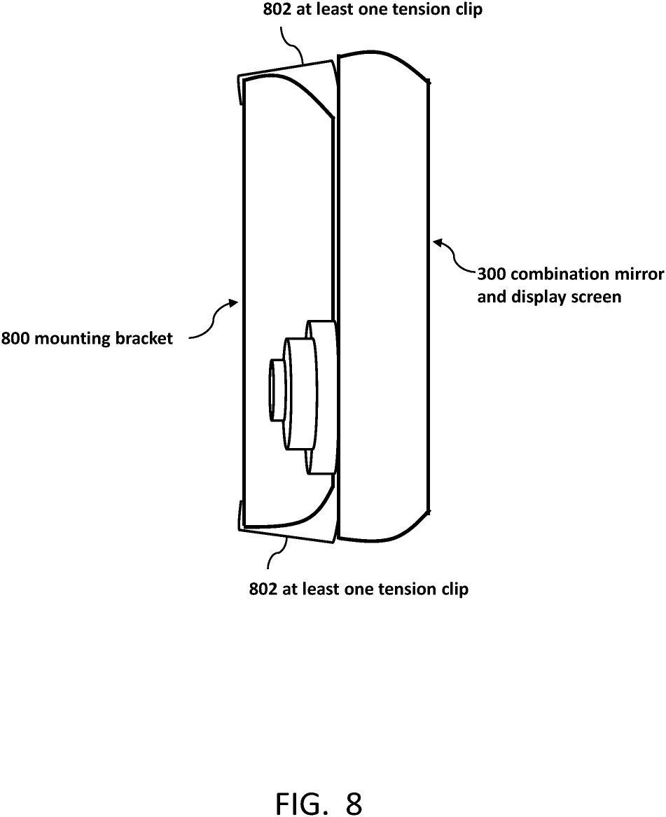

FIGS. 5A and 5B are front views illustrating a handle for positioning a combination and display screen. As illustrated in FIGS. 5A and 5B, handle 310 may be configured to move between a first position 500a and a second position 500b. In some embodiments, in first position 500a, handle 310 is configured to extend along a first direction parallel to housing 302. In the second position 500b, handle 310 may be configured to extend along a second direction perpendicular to housing 302. In some embodiments, the first position 500a is configured to store the combination mirror and display screen 300, while the second position 500b is configured for portable use of the combination mirror and display screen 300. First position 500a may also be configured for the use of a combination mirror and display screen 300 when a combination mirror and display screen 300 is coupled to another device, such as a rearview mirror or bracket, as shown in FIGS. 7 and 8.

FIG. 6 is a side view of the combination mirror and display screen illustrating the first and second fields of view. FIG. 6 shows the first field of view 600a, mentioned above. In some embodiments, the camera 308 is configured to record a second field of view 600b, as illustrated in FIG. 6. First field of view 600a may be located opposite the second field of view 600b. In some embodiments, there is some overlap between the first field of view 600a and the second field of view 600b. As previously mentioned, mirrored surface 2402 of the display screen 400 may be configured to reflect at least a portion of the first field of view 600a. Display screen 400 may also be configured to display the second field of view 600b as recorded by camera 308. Display screen 400 may be configured to display the second field of view 600b in substantially real-time. In some embodiments, display screen 400 is configured to simultaneously display both the first field of view 600a and the second field of view 600b. The display screen 400 may be configured to alternate between the first field of view 600a and the second field of view 600b. Embodiments disclosed herein, including the combination mirror and display screen, may be implemented with fully wireless connectivity.

FIG. 7 illustrates a side view of the combination mirror and display screen 300 coupled to the rearview mirror 700. In some embodiments, rearview mirror 700 comprises a rearview mirror of a vehicle, such as an automobile, an off-road vehicle, a golf cart, or any other suitable type of vehicle. Combination mirror and display screen 300 may be detachably coupled to rearview mirror 700 via an attachment mechanism 702, as shown in FIG. 7. In some embodiments, attachment mechanism 702 comprises at least one attachment mechanism 702. Attachment mechanism 702 may be used with the embodiments disclosed herein. Attachment mechanism 702 may comprise at least one strap, at least one stretchable band, at least one clip, or any other suitable type of attachment mechanism. In some embodiments, when the combination mirror and display screen 300 is coupled to the rearview mirror 700, the back side 306 of housing 302 is configured to contact the front surface of the rearview mirror 700. Accordingly, when coupled to rearview mirror 700, mirrored surface 2402 of viewing side 304 may be configured to serve as a replacement rearview mirror.

Similar to FIG. 7, FIG. 8 shows the combination mirror and display screen 300 coupled to mounting bracket 800. In some embodiments, the mounting bracket 800 comprises a housing coupled to a vehicle in place of a traditional rearview mirror. For example, a user may remove the original rearview mirror and install mounting bracket 800 to use the combination mirror and display screen 300 rather than the original rearview mirror. In some embodiments, the combination mirror and display screen 400 are configured to couple to mounting bracket 800 via at least one tension clip 802, as shown in FIG. 8. Combination mirror and display screen 300 may be configured to couple to mounting bracket 800 via any suitable mechanism to enable detachable coupling.

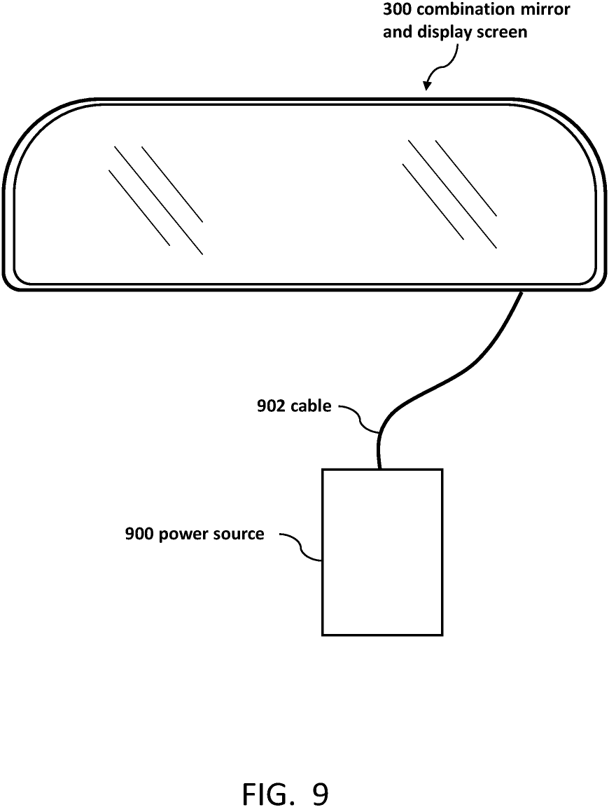

FIG. 9 is a front view/diagram illustrating the combination mirror and display screen 300 coupled to power source 900 via cable 902. The combination mirror and display screen 300 may include a power button electrically coupled to at least one of the power source 900, display screen 400, and the camera 308. In some embodiments, power source 900 comprises a rechargeable battery, such as a lithium-ion battery. Power source 900 may comprise DC power, such as power supplied via a charger located in a vehicle, or AC power, such as power supplied by a traditional power outlet. For example, power source 900 comprising DC power may include a cigarette lighter in a vehicle. In some embodiments, the combination mirror and display screen 300 is configured to receive power from both DC (or AC) power and a rechargeable battery. DC (or AC) power may be used to charge the rechargeable battery so that the combination mirror and display screen 300 is ready for portable use with a substantially full battery charge. Power source 900 may also comprise different sources of power, such as a solar battery pack, a solar-powered generator, a gas-powered generator, an electric power bank, or any other sources of power. In some embodiments, a combination mirror and display screen 300, including camera 308, is configured to operate for about twelve hours on a fully-charged battery. The combination mirror and display screen 300 may be configured to operate for more than twelve hours. In some embodiments, the combination mirror and display screen 300 is configured to operate for fewer than twelve hours.

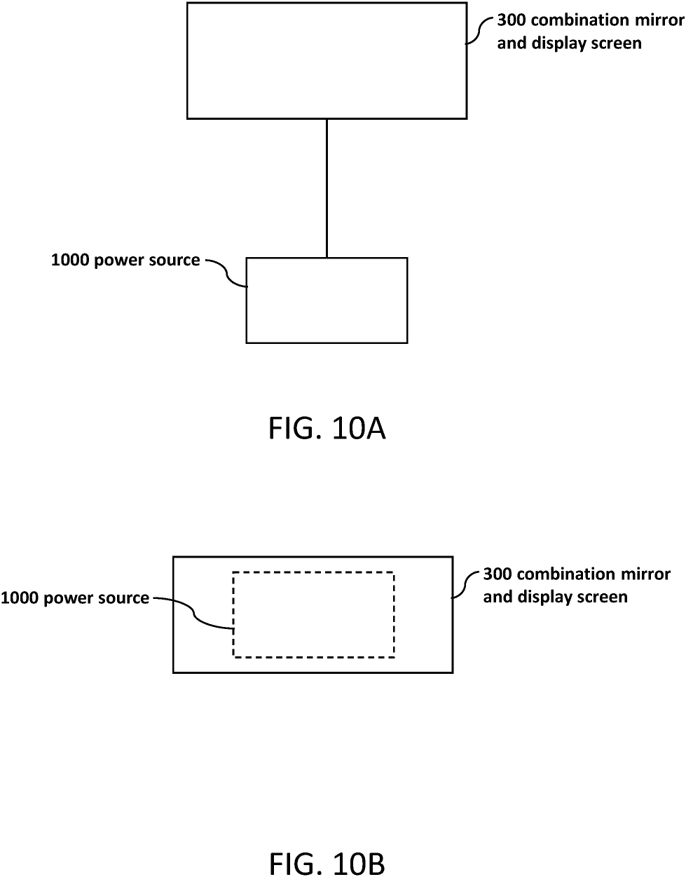

FIGS. 10A and 10B illustrate diagrams of the combination mirror and display screen 300 coupled to power source 1000. It should be noted that power source 1000 may comprise the same power source as power source 900, shown in FIG. 9. In some embodiments, as shown in FIG. 10A, power source 1000 is coupled to the combination mirror and display screen 300, for example, via a cable port. Power source 1000 may be located within a combination mirror and display screen 300, as illustrated in FIG. 10B. For example, power source 1000 shown in FIGS. 10A and 10B may comprise any number of power sources, including, but not limited to, an AC power supply, a DC power supply, a solar battery pack, a solar-powered generator, a gas-powered generator, an electric power bank, and a rechargeable battery, such as a lithium-ion battery. In some embodiments, power source 900 and power source 1000 comprise more than one power source; for example, a plurality of rechargeable batteries or both AC and DC power supplies.

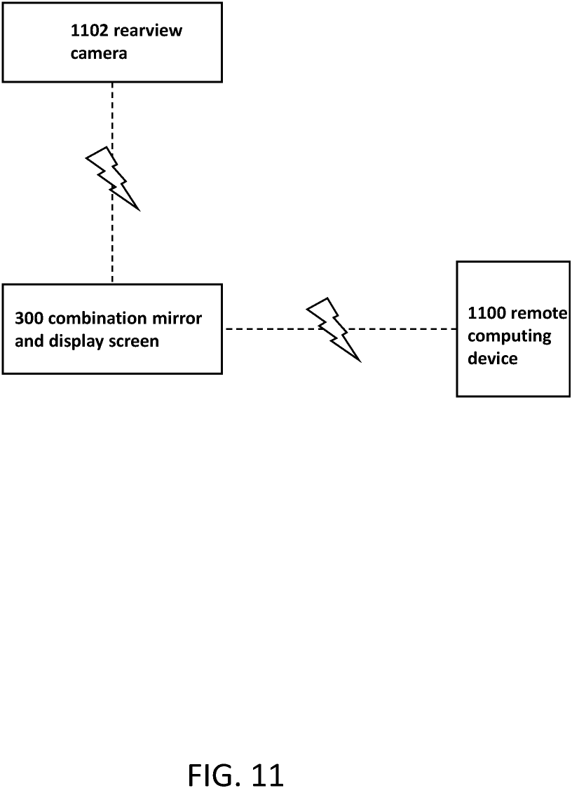

In some embodiments, the camera 308 is coupled to display screen 400 via a wired connection. Camera 308 may be wirelessly coupled to display screen 400, such as via Bluetooth, WiFi, cellular, or any other wireless communication protocol. FIG. 11 shows that wireless connectivity may also be used to couple the combination mirror and display screen 300 to a remote computing device 1100, such as a smartphone, tablet, laptop, or any other remote computing device. In some embodiments, remote computing device 1100 is configured to run a mobile application. Similar to display screen 400, the mobile application may be configured to display the second field of view 600b as recorded by camera 308. Accordingly, a user of remote computing device 1100 may remotely view a recording from camera 308. For example, a user(s) of combination mirror and display screen 300 (e.g., one parent and child on a road trip) may share their experience with the user of the remote computing device 1100 (e.g., the other parent not on the trip). Remote computing device 1100 may be configured to display the second field of view 600b as recorded by camera 308 in substantially real-time (i.e., with only a few seconds of delay). Remote computing device 1100 may also be configured to display a recording that was captured by camera 308 at an earlier time and stored on a storage medium, as will be discussed in greater detail later in this disclosure.

FIG. 11 illustrates a block diagram showing an embodiment that includes rearview camera 1102. Similar to camera 308, rearview camera 1102 may be wirelessly coupled to a combination mirror and display screen 300 so that display screen 400 displays what is recorded by rearview camera 1102. In some embodiments, rearview camera 1102 is configured to record at least a portion of the first field of view 600a. For example, rearview camera 1102 may be coupled to a trunk or rear-access door of a vehicle and may be configured to record an area behind the vehicle. As discussed above with reference to camera 308, remote computing device 1100 may be configured to display what is recorded by rearview camera 1102 via a mobile application. In some embodiments, the combination mirror and display screen 300 is wirelessly coupled to a plurality of remote computing devices 1100, such that recordings from camera 308 and/or rearview camera 1102 are shared with multiple remote computing devices 1100. Accordingly, multiple users of different remote computing devices 1100 may be able to view recordings, both stored and real-time, captured by camera 308 and rearview camera 1102.

Combination mirror and display screen 300 may include a storage medium configured to store at least one recording captured by camera 308. In some embodiments, the storage medium and camera 308 are configured to loop the recording after a predetermined amount of time. For example, the recording may loop every 10 minutes, every 20 minutes, every 30 minutes, every hour, or any other amount of time. In some embodiments, the combination mirror and display screen 300 includes a button configured to save a recording. The ability to save a recording may enable a user to capture an important event, like a car accident, animal sighting, or other notable event, and watch it again later. In some embodiments, the storage medium comprises a secure digital (“SD”) card.

None of the steps described herein is essential or indispensable. Any of the steps can be adjusted or modified, and other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are non-limiting. The section headings and subheadings do not represent or limit the full scope of the embodiments described in the sections to which the headings and subheadings pertain. For example, a section titled “Topic 1” may include embodiments that do not pertain to Topic 1, and embodiments described in other sections may apply to and be combined with embodiments described within the “Topic 1” section.

To increase the clarity of various features, other features are not labeled in each figure.

The various features and processes described above may be used independently of one another or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, parallel, or other ways. Tasks or events may be added or removed from the disclosed example embodiments. The example systems and components described herein may be configured differently than described. For example, elements may be added to, removed from, or rearranged compared to the disclosed example embodiments.

The conditional language used herein, such as, among others, “can,” “could,” “might,” “may,” “e.g.,” and the like, unless expressly stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless expressly stated otherwise, is otherwise understood with the context as used in general to convey that an item, term, etc., may be either X, Y, or Z. Thus, such conjunctive language is not generally intended to imply that certain embodiments require at least one of X, at least one of Y, and at least one of Z to each be present.

The term “and/or” means that “and” applies to some embodiments, and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

The term “substantially” is used to mean “completely” or “nearly completely.” For example, the disclosure includes, “The display screen 2400 may be configured to display the second field of view 4600b in substantially real-time.” In this context, “substantially real-time” is used to mean that the display screen 2400 may display the second field of view 4600b in real-time or with a slight delay, such as a few seconds.

The various features and processes described above may be used independently of one another or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added or removed from the disclosed example embodiments. The example systems and components described herein may be configured differently than described. For example, elements may be added to, removed from, or rearranged compared to the disclosed example embodiments.

The foregoing may be accomplished through software code running in one or more processors on a communication device in conjunction with a processor in a server running complementary software code.

Some of the devices, systems, embodiments, and processes use computers. Each of the routines, processes, methods, and algorithms described in the preceding sections may be embodied in and fully or partially automated by code modules executed by one or more computers, computer processors, or machines configured to execute computer instructions. The code modules may be stored on any type of non-transitory computer-readable storage medium or tangible computer storage device, such as hard drives, solid-state memory, flash memory, optical disc, and/or the like. The processes and algorithms may be implemented partially or wholly in application-specific circuitry. The results of the disclosed processes and process steps may be stored, persistently or otherwise, in any non-transitory computer storage, such as, e.g., volatile or non-volatile storage.

It is appreciated that to practice the method of the foregoing as described above, it is not necessary that the processors and/or the memories of the processing machine be physically located in the same geographical place. That is, each of the processors and the memory (or memories) used by the processing machine may be located in geographically distinct locations and connected to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the foregoing, be performed by a single component. Further, as described above, the processing performed by one distinct component may be performed by two distinct components. Similarly, the memory storage performed by two particular memory portions, as described above, may, in accordance with a further embodiment of the foregoing, be performed by a single memory portion. Further, the memory storage, performed by one distinct memory portion described above, may be performed by two memory portions.

Further, various technologies may be used to provide communication between the various processors and/or memories, as well as to allow the processors and/or the memories of the foregoing to communicate with any other entity, i.e., to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol, such as TCP/IP, UDP, or OSI, for example.

As described above, a set of instructions may be used to process the foregoing. The collection of instructions may be in the form of a program or software. The software may be in the form of system software or application software, for example. The software might also be a collection of separate programs, a program module within a larger program, or a portion of a program module, for example. The software used might also include modular programming in the form of object-oriented programming. The software may instruct the processing machine on what to do with the data being processed.

Further, it is appreciated that the instructions or set of instructions used in the implementation and operation of the foregoing may be in a suitable form such that the processing machine may read the instructions. For example, the instructions that form a program may be in the form of a suitable programming language, which is converted to machine language or object code to allow the processor or processors to read the instructions. That is, written lines of programming code or source code in a particular programming language are converted to machine language using a compiler, assembler, or interpreter. The machine language is binary-coded machine instructions specific to a particular type of processing machine, i.e., to a particular type of computer, for example. The computer understands the machine language.

Any suitable programming language may be used in accordance with the various embodiments of the foregoing. Illustratively, the programming language used may include assembly language, Ada, APL, Basic, C, C++, COBOL, dBase, Forth, Fortran, Java, Modula-2, Pascal, Prolog, Python, REXX, Visual Basic, and/or JavaScript, for example. Further, it is not necessary that a single type of instruction or single programming language be utilized in conjunction with the operation of the system and method of the foregoing. Rather, any number of different programming languages may be utilized as necessary and/or desirable.

Also, the instructions and/or data used in the practice of the foregoing may utilize any compression or encryption technique or algorithm as may be desired. An encryption module might be used to encrypt data. Further, files or other data may be decrypted using a suitable decryption module, for example.

As described above, the foregoing may illustratively be embodied in the form of a processing machine, including a computer or computer system, for example, that includes at least one memory. It is to be appreciated that the set of instructions, i.e., the software, for example, that enables the computer operating system to perform the operations described above, may be contained on any of a wide variety of media or medium, as desired. Further, the data processed by the set of instructions might also be contained in a wide variety of media or medium. That is, the particular medium, i.e., the memory in the processing machine, utilized to hold the set of instructions and/or the data used in the foregoing may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmissions, as well as any other medium or source of data that may be read by the processors of the foregoing.

Further, the memory or memories used in the processing machine that implements the foregoing may be in various forms to allow the memory to hold instructions, data, or other information, as desired. Thus, the memory might be in the form of a database to hold data. The database might use any desired arrangement of files, such as a flat file arrangement or a relational database arrangement, for example.

In the system and method of the foregoing, a variety of “user interfaces” may be utilized to allow a user to interface with the processing machine or machines used to implement the foregoing. As used herein, a user interface includes any hardware, software, or combination of hardware and software used by the processing machine that allows a user to interact with the processing machine. A user interface may be in the form of a dialogue screen, for example. A user interface may also include any of a mouse, touch screen, keyboard, keypad, voice reader, voice recognizer, dialogue screen, menu box, list, checkbox, toggle switch, a pushbutton, or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user to convey or receive information from the user. However, it should be appreciated that in accordance with some embodiments of the system and method of the foregoing, it is not necessary that a human user actually interacts with a user interface used by the processing machine of the foregoing. Rather, it is also contemplated that the user interface of the foregoing might interacts, i.e., convey and receive information, with another processing machine rather than a human user. Accordingly, the other processing machine might be characterized as a user. Further, it is contemplated that a user interface utilized in the system and method of the foregoing may interact partially with another processing machine or processing machines while also interacting partially with a human user.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in various forms; furthermore, various omissions, substitutions, and changes in the form of the methods and systems described herein may be made without departing from the spirit of the inventions disclosed herein.

What is claimed is:

1. A system, comprising:
a housing;
a display attached to the housing; and
a camera attached to the housing located proximate the display, the camera being configured to capture images over a 360-degree field of view in at least a first plane through the housing and capture images over a 220-degree field of view in a second plane perpendicular to the first plane.

2. The system of claim 1, wherein the camera is attached to an edge of the housing.

3. The system of claim 1, further comprising a processor coupled to the camera.

4. The system of claim 3, further comprising a night-vision system coupled to the camera.

5. The system of claim 3, wherein the processor is programmed by a computer-readable, non-transitory, programmable product, comprising code, executable by the processor, for causing the processor to do the following:
recognize objects captured by the camera according to a predetermined characteristic; and
provide an alert in connection with recognition of an object.

6. The system of claim 5, wherein the objects include one or more weapons and one or more hazards.

7. The system of claim 5, wherein the objects recognized by the processor include one or more human faces.

8. The system of claim 4, wherein the processor is programmed by a computer-readable, non-transitory, programmable product comprising code, executable by the processor, for causing the processor to do the following:
recognize objects captured by the camera according to a predetermined characteristic; and
provide an alert in connection with recognition of an object.

9. The system of claim 8, wherein the objects include one or more hazards, including one or more weapons.

10. The system of claim 8, wherein the objects recognized by the processor include one or more human faces.

11. The system of claim 3, further comprising supplementary code, executable by the processor, for causing the processor to cause the camera to zoom in on objects in the field of view of the camera recognized as a hazard by the processor.

12. The system of claim 4, further comprising supplementary code, executable by the processor, for causing the processor to cause the camera to zoom in on objects in the field of view of the camera recognized as a hazard by the processor.

13. A detachable rear-view driving system, comprising:
a housing;
an attachment system for detachably affixing over a rear-view mirror in a vehicle;
a display attached to the housing;
a camera attached to the housing located proximate the display, the camera being configured to capture images over a 360-degree field of view in at least a first plane through the housing and capture images over a 220-degree field of view in a second plane perpendicular to the first plane;
a processor coupled to the camera and
a communication system coupled to the processor.

14. The system of claim 13, wherein the camera is attached to an edge of the housing, the system further comprising a night-vision system coupled to the camera.

15. The system of claim 13, further comprising one or more additional cameras coupled to the display and the processor.

16. The system of claim 13, wherein the processor is programmed by a computer-readable, non-transitory, programmable product, comprising code, executable by the processor, for causing the processor to do the following:
recognize objects captured by the camera according to a predetermined characteristic; and
provide an alert in connection with recognition of an object.

17. The system of claim 16, wherein the objects are selected from the group consisting of one or more weapons, one or more hazards, and one or more human faces.

18. The system of claim 17, wherein the camera is attached to an edge of the housing.

19. The system of claim 18, the system further comprising a night-vision system coupled to the camera, wherein the processor is programmed by a computer-readable, non-transitory, programmable product, comprising code, executable by the processor, for causing the processor to do the following:
recognize objects captured by the camera according to a predetermined characteristic; and
provide an alert in connection with recognition of an object wherein the objects are selected from the group consisting of one or more hazards, one or more weapons, and one or more human faces.

20. The system of claim 19, wherein the processor is further programmed by supplementary code, executable by the processor, for causing the processor to cause the camera to zoom in on objects in the field of view of the camera recognized as a hazard by the processor.
